(19) United States
(12) Patent Application Publication
(10) Pub. No.: US 2023/0281490 A1
(43) Pub. Date: Sep. 7, 2023

(54) METHODS AND SYSTEMS FOR AUTOMATIC GENERATION OF SCIENTIFIC HYPOTHESES

(71) Applicant: Palo Alto Research Center Incorporated, Palo Alto, CA (US)

(72) Inventors: Morad BEHANDISH, San Mateo, CA (US); John MAXWELL, III, Santa Clara, CA (US); Johan de Kleer, Los Altos, CA (US)

(73) Assignee: Palo Alto Research Center Incorporated, Palo Alto, CA (US)

(21) Appl. No.: 17/684,100

(22) Filed: Mar. 1, 2022

(51) Int. Cl. G06N 5/04

(52) U.S. Cl. CPC G06N 5/041

(57) ABSTRACT

Methods and systems useful for artificial intelligence-assisted generation of viable hypotheses may have (1) an ability to rapidly enumerate and test a diverse set of mathematically sound and parsimonious physical hypotheses, starting from a few basic assumptions on the embedding spacetime topology; (2) a distinction between non-negotiable mathematical truism (e.g., conservation laws or symmetries), that are directly implied by properties of spacetime, and phenomenological relations (e.g., constitutive laws), whose characterization relies indisputably on empirical observation, justifying targeted use of data-driven methods (e.g., machine learning (ML) or polynomial regression); and (3) a “simple-first” strategy (following Occam’s razor) to search for new hypotheses by incrementally introducing latent variables that are expected to exist based on topological foundations of physics.

### STATEMENT REGARDING FEDERALLY SPONSORED RESEARCH AND DEVELOPMENT

This invention was made with Government support under contact number HR00111990029 awarded by DARPA. The Government has certain rights in this invention.

### FIELD OF INVENTION

The present disclosure relates methods and systems for artificial intelligence (AI)-assisted generation of viable scientific hypotheses.

### BACKGROUND

As computational power and data sources are becoming more ubiquitous, model-based, data-driven, and hybrid AI methods are playing an increasingly more important role in various scientific activities.

Data-driven AI methods have been applied extensively within the past few decades to distill nontrivial physics-based insights (scientific discovery) and to predict complex dynamical behavior (scientific simulation). Notwithstanding their effectiveness and efficiency in classification, regression, and forecasting tasks, statistical learning methods can hardly ever evaluate the soundness of a function fit, explain the reasons behind observed correlations, or provide sufficiently strong guarantees to replace parsimonious and explainable scientific expressions such as differential equations (DE). Hybrid methods such as constructing physics-informed/inspired/guided architectures for neural nets and loss functions that penalize both predication and DE residual errors and graphical networks based on control theory and combinatorial structures are all important steps towards explainability. However, the built-in ontological biases in most machine learning (ML) frameworks prevent them from thinking outside the box to discover not only the known-unknowns, but also unknown-unknowns, during early stages of the scientific process.

### SUMMARY OF INVENTION

The present disclosure relates methods and systems for artificial intelligence-assisted generation of viable hypotheses.

A nonlimiting example of the present disclosure is a method for identifying, generating, and/or evaluating scientific hypotheses, the method comprising: describing a context for a physical system in terms of its underlying topology and a domain of interest; defining a plurality of physical variables and relation types based on the underlying topology and the domain of interest; representing a plurality of testable hypotheses each as a network or graph-like structure comprising physical relationships among the physical variables, wherein the physical relationships are selected from the relationship types, and wherein, within the network or graph-like structure, the physical variables are nodes and the physical relationships are edges; interpreting at least one of the testable hypotheses into analytical and/or computational forms with a combination of known and unknown variables; and validating or invalidating the at least one of the testable hypotheses by (a) fitting the unknown parameters to data relating to the physical system and (b) evaluating a goodness of fit for the fitting.

Another nonlimiting example of the present disclosure is a system that comprises: a processor; a memory coupled to the processor; and instructions provided to the memory, wherein the instructions are executable by the processor to cause the system to perform a method comprising: describing a context for a physical system in terms of an underlying topology and a domain of interest; defining a plurality of physical variables and relation types based on the underlying topology and the domain of interest; representing a plurality of testable hypotheses each as a network or graph-like structure comprising physical relationships among the physical variables, wherein the physical relationships are selected from the relationship types, and wherein, within the network or graph-like structure, the physical variables are nodes and the physical relationships are edges; interpreting at least one of the testable hypotheses into analytical and/or computational forms with a combination of known and unknown variables; and validating or invalidating the at least one of the testable hypotheses by (a) fitting the unknown parameters to data relating to the physical system and (b) evaluating a goodness of fit for the fitting.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1A illustrates a nonlimiting example of an abstract (symbolic) interaction network (I-net) over a single

$$D \text{-space} \text{.}$$

FIG. 1B illustrates a nonlimiting example of an abstract (symbolic) I-net over on a product of a

$${D}_{1} \text{-space}$$

and a

$${D}_{2} \text{-space} \text{.}$$

FIG. 2A illustrates a simple pendulum considered in a nonlimiting example generation of hypotheses.

FIG. 2B illustrates a nonlimiting example search tree that starts at a root or initial I-net for the pendulum of FIG. 2A.

FIG. 2C illustrates I-net representations of generated hypotheses along the search tree of FIG. 2B for the pendulum of FIG. 2A.

### DETAILED DESCRIPTION

The present disclosure relates methods and systems for artificial intelligence (AI)-assisted generation of viable hypotheses. More specifically, the present disclosure describes a ‘cyber-physicist’ (CyPhy), an AI research associate for early-stage scientific process of hypothesis generation and initial validation or invalidation, grounded in the most invariable mathematical foundations of classical and relativistic physics. The framework distinguishes itself from existing rule-based reasoning, statistical learning, and hybrid AI methods by: (1) an ability to rapidly enumerate and test a diverse set of mathematically sound and parsimonious physical hypotheses, starting from a few basic assumptions on the embedding spacetime topology; (2) a distinction between non-negotiable mathematical truism (e.g., conservation laws or symmetries), that are directly implied by properties of spacetime, and phenomenological relations (e.g., constitutive laws), whose characterization relies indisputably on empirical observation, justifying targeted use of data-driven methods (e.g., machine learning (ML) or polynomial regression); and (3) a “simple-first” strategy (following Occam’s razor) to search for new hypotheses by incrementally introducing latent variables that are expected to exist based on topological foundations of physics.

Further, the AI research associate may bridge multiple levels of abstraction, using a domain-agnostic representation scheme (referred to herein as an interaction network or I-net) to express a wide range of mathematically viable physical hypotheses (e.g., candidates for theories/laws) from Kepler’s and Newton’s laws to elastodynamics in composite materials, by exploiting common structural invariants across physics. Said approach entails: (a) defining a relatively unbiased ontology that is rooted in fundamental abstractions (also referred to as conservation laws) that are common to all known theories of classical and relativistic physics; (b) constructing a constrained search space to enumerate viable hypotheses with postulated invariants (e.g., built-in conservation laws that are consistent with the presupposed spacetime topology); and (c) automatically assembling interpretable ML architectures for each hypothesis, to estimate parameters for phenomenological relations (also referred to herein as constitutive laws) from empirical data.

At the core of (a) is a powerful mathematical abstraction of physical governing equations rooted in algebraic topology and differential geometry, leading to an ontological commitment to the relationship between physical measurement and basic properties of the embedding spacetime - but nothing more, to leave room for innovation and surprise. This relationship has been shown to be responsible for curious analogies and common structure across physics which is exploited in (b), along with search heuristics based on analogical reasoning. Each viable hypothesis is automatically compiled to an interpretable “computation graph” for a given cellular decomposition of embedding spacetime using well-established concepts from cellular homology and exterior calculus of differential and discrete forms that are under-utilized in AI. The computation graphs is a tensor-based architecture, akin to a neural net with convolution layers to compute differentiation integration and (non)linear local operators for constitutive equations.

### Interaction Networks (I-Nets)

The interaction networks or I-nets described herein may be based on a generalization of Tonti diagrams that is expressive and versatile enough to accommodate novel scientific hypotheses, while retaining a basic commitment to philosophical principles such as parsimony (Occam’s razor), measurement-driven classification of variables, and separation of non-negotiable mathematical properties of spacetime (homology) from domain-specific empirical knowledge (phenomenology). Data science is employed to help only with the latter.

Generally, the I-net may describe the context (e.g., user-defined assumptions on a spacetime topology, semantics of physical quantities, and structural restrictions) of a physical system (e.g., a material or part of a larger physical system that may fail with acting outside forces, movement of a pendulum with acting outside forces, operation of a circuit, and the like) in terms of an underlying topology and a domain of interest (e.g., a mechanical domain, an electrical domain, a thermal domain, or any combination thereof) within physical system. The underlying topology may pertain to a physical space of the physical system, a time of the physical system, a spacetime of the physical system, an abstract system network of the physical system, or any combination thereof. An abstract system network may be electrical circuits, chemical reaction networks, system models, bond graphs, flow diagrams, port-Hamiltonian representations, coordinate grids, structured or unstructured meshes, or any combination thereof in continuum, discrete, or mixed settings.

Three levels of abstraction are conceptualized and are related by inheritance: abstract (symbolic) I-nets, discrete (cellular) I-nets, and numerical (tensor-based) I-nets. At each level, an I-net instance is contextualized by user-defined assumptions on a spacetime topology, semantics of physical quantities, and structural restrictions on allowable diagrams based on analogical reasoning and domain-specific insight (if available). Each I-net instance may distinguish between topological and metric operators. However, I-nets have additional degrees of freedom (e.g., beyond Tonti diagrams) for the data science to allow for phenomenological relations among variables that may not be dual to each other. This is motivated by the observation that some existing middle-ground theories use phenomenological relations to capture a combination of topological and metric aspects.

Once the context of the physical system description is described, the physical variables (e.g., a plurality of physical variables) and their relation (or relationship type) to each other may be defined within the underlying topology and the domain of interest. The types of physical variables may be parameters within and/or derived from the data relating to the physical system like force applied to a physical system, temperature, pressure, resistance, conductivity, and the like. The relationship type may be derived by prescribing, defining, and/or constraining a conservation law and/or a constitutive law. The relationship types may comprise one or more selected from the group consisting of: a topological relation, a metric relation, an algebraic relation, a differential operator, an integral operator, and an interpolative operator.

An abstract (symbolic) I-net may be defined on a single

$$D \text{-space}$$

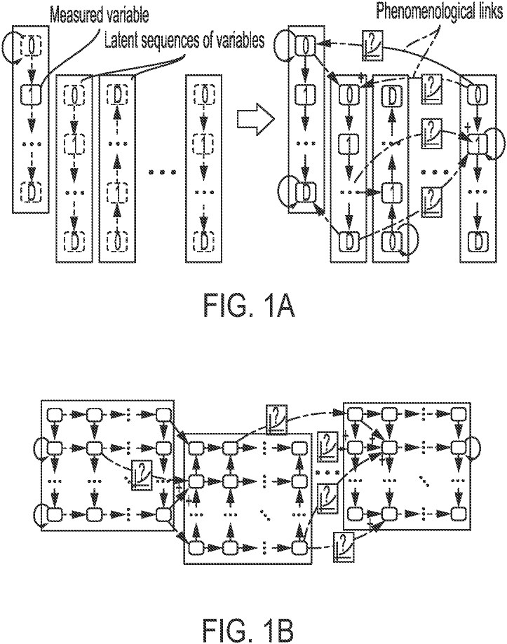

as a finite collection of primary and/or secondary co-chain complexes that are inter-connected by phenomenological links (also referred to herein as constitutive laws), as illustrated in FIG. 1A. Each co-chain complex is a sequence of (symbolic) d-forms related by (symbolic) co-boundary operators from d-forms to (d + 1)-forms

$$\left(0 \leq d \leq D\right) .$$

The interpretation of d ➔ (d + 1) maps depends on the embedding dimension

$$D .$$

For instance, if

$$D = 1$$

the only option for the input is d = 0 leading to a simple partial derivative (0 ➔ 1). Whereas for

$$D = 3$$

, one can have d = 0; 1; 2 leading to gradient (0 ➔ 1), curl (1 ➔ 2), and divergence (2 ➔ 3) operations, respectively.

These sequences may represent different domains of physics (e.g., mechanical, electrical, thermal, and the like) within a physical system. Although, for most known physics, each domain’s theory appears as one pair of (primary and secondary) sequences in tandem, connected by horizontal (or horizontal-diagonal) constitutive relations leading to Tonti diagrams, such restriction are not made here when looking for new theories. The cross-sequence links can thus represent both single-physics constitutive relations and mutli-physics coupling interactions. Conservation laws, on the other hand, are represented by a balance between the output of a topological operator and an external source/sink, the latter being represented by a loop.

It is often more convenient to define product spaces (e.g., separate 3D space and 1D time, as opposed to 4D spacetime) in which conservation laws are stated as sums of incoming topological relations being balanced against an external source/sink. To accommodate such representations, abstract (symbolic) I-nets are defined on a product of a

$${D}_{1} \text{-space}$$

and a

$${D}_{2} \text{-space}$$

as multi-sequences of co-chains, connected by phenomenological links, as before. It is possible to form 2² = 4 possible such multi-sequences with various orientation combinations, two of which lead to so-called mechanical and field theories, shown in FIG. 1B for higher-dimensional pairs of abstract topological spaces. This construction is generalized to products of more than two spaces in a straightforward combinatorial fashion.

Based on topological context, the semantics for co-boundary operators is unambiguously determined by the dimensions of the two variables (i.e., co-chains) they relate. However, phenomenological links require specifying a parameterization of possibly nonlinear, in-place, and purely metric relations they represent, using unknown parameters that must be learned from data.

For I-net nodes that have a single incoming edge, the node’s variable may be equated with the output of the topological operator or phenomenological function assigned to the edge. For nodes with multiple incoming edges, the outputs of these edges are summed and equated to the node’s variable. For nodes with one or more outgoing edges, each edge consumes the node’s variable as input. Loops are no exception, as they introduce in-place constraints on the node’s variable, including initial/boundary conditions or source/sink terms.

Once one or more hypotheses are specified in the language of abstract (symbolic) I-nets with unknown phenomenological parameters (e.g., thermal conductivity in the earlier heat transfer example), the parameters may be optimized to fit the data and the regression error may be used to evaluate the fitness of hypotheses.

Having defined a combinatorial representation of viable hypotheses that can be partially ordered in terms of complexity, generation and testing the hypotheses may occur in a simple-first fashion. The search space may be defined by a directed acyclic graph (DAG) whose nodes (i.e., states) represent symbolic I-net instances. The edges (i.e., state transitions) represent generating a new I-net structure by incrementally adding complexity to the parent state. Each action can be one or composition of (a) defining a new symbolic variable, in an existing co-chain complex, by applying a topological operator to an existing variable; (b) defining a new variable in a latent co-chain complex; and (c) adding phenomenological links of prescribed form and unknown parameters, connecting existing variables. The search may be guided by a loss function determined by how well the hypotheses represented by these I-net structures explain a given data set. The algorithm may also be equipped with heuristic rules (e.g., set by the user based on domain knowledge or insight, if available) to prune the search space or prioritize paths that are perceived as more likely due to structural analogies with existing theories.

Given the bare minimum contextual information such as the assumed underlying topology, a preset number of physical domains, and the types of measured variables (e.g., spatiotemporal associations, tensor ranks and shapes, and dimensions/units), the search starts from an initial I-net instance (i.e., the root) that embodies only measured variable(s) with no initial edges except the ones that are asserted a priori (e.g., loops for initial/boundary conditions or source terms, if applicable). The spatio-temporal types and physical semantics for these variables are provided by the experimentalist.

After the plurality of physical variables and relation types using the underlying topology and the domain of interest, a plurality of testable hypotheses may each be represented as a network or graph-like structure comprising physical relationships among the physical variables. The physical relationships may be selected from the relationship types, and within the network or graph-like structure, the physical variables may be nodes and the physical relationships are edges. The at least one of the testable hypotheses may comprise at least one of conservation laws derived from first principles applied to (a) the underlying topology, (b) phenomenological, empirical, constitutive, material, or multi-physics interaction laws expressed in algebraic terms with the unknown parameters, and (c) initial or boundary conditions.

In one example, the plurality of testable hypotheses may be arranged in a search space that is represented by a directed acyclic graph (DAG) whose nodes are the testable hypotheses and edges are the actions in the search space representing one or more of: (a) adding one or more new relations among existing physical variables; or (b) defining one or more new physical variables linked to one or more existing variables with one or more new physical relations.

After representing a plurality of testable hypotheses each as a network or graph-like structure, at least one of the testable hypotheses may be interpreted into analytical and/or computational forms with a combination of known and unknown variables. Then, the at least one of the testable hypotheses may be validated or invalidated by (a) fitting the unknown parameters to data (e.g., simulation, experiment, or a combination of both) relating to the physical system and (b) evaluating a goodness of fit for the fitting. The analytical and/or computational forms may be one or more of: a differential equation, an integral equation, an integro-differential equation, a discrete-algebraic equation, and a system model.

For example, performing the interpreting and the validating or invalidating for multiple of the plurality of testable hypotheses search, wherein the interpreting and the validating or invalidating for the multiple of the plurality of testable hypotheses is performed for simpler testable hypotheses and proceeds to other testable hypotheses that adds complexity incrementally if the simpler hypotheses do not explain the data adequately.

In another example, the network or graph-like structure may comprise one or more equations in terms of the physical variables and the known and unknown parameters. Then, the validating or invalidating may comprise fitting the one or more equations to available data.

The interpreting of the at least one of the testable hypotheses may include mapping the physical variables to tensor data and physical relationships to computational operators in a computational framework. To achieve this mapping techniques such as machine learning, optimization platforms, numerical solvers or simulation platforms, or a combination thereof may be used.

The fitting during validating or invalidating may be guided by a loss function, an error function, a cost function, an objective function, a utility function, or penalty function that quantifies how well a testable hypothesis explains the data.

The systems and methods described herein may further include outputting and/or displaying at least one of: (a) the underlying topology and the domain of interest, (b) the network or graph-like structure for the at least one of the testable hypotheses, (c) the analytical and/or computational forms for the at least one of the testable hypotheses, (d) the search space, (e) the validation or invalidation for the at least one of the testable hypotheses, and (f) the goodness of fit for the at least one of the testable hypotheses.

The systems and methods described herein may further include collecting additional data; and validating or invalidating at least some of the plurality of testable hypotheses with the additional data.

To facilitate a better understanding of the embodiments of the present invention, the examples implementing the systems and methods of the present disclosure are described throughout the description. Said examples should not be read to limit, or to define, the scope of the invention.

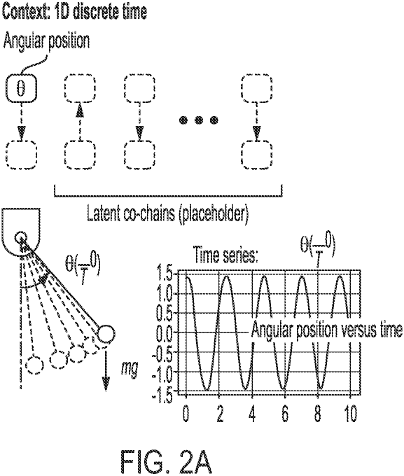

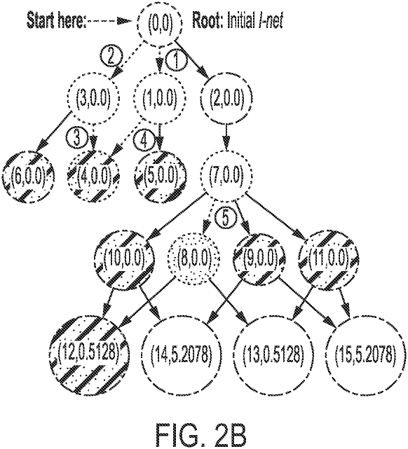

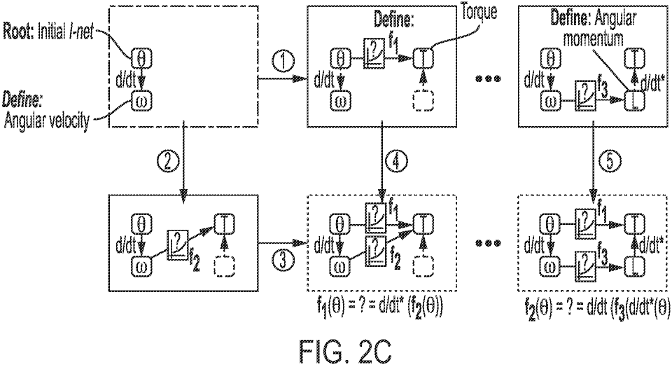

For example, when considering a simple pendulum illustrated in FIG. 2A, 1D time is considered, leading to a topological space of inter-connected time instants

$${\overline{τ}}^{0} , {\tilde{τ}}^{0} = {\overline{τ}}^{0} + \frac{∈}{2}$$

and time intervals

$${\overline{τ}}^{1} = \left({\overline{τ}}^{0} , {\overline{τ}}^{0} + ∈\right) , {\overline{τ}}^{1} = \left({\tilde{τ}}^{1} , {\tilde{τ}}^{1} + ∈\right)$$

to which data may be associated. Suppose we are given time series data for angular position

$$θ \left({\overline{τ}}^{0}\right) .$$

The initial I-net instance is a single symbolic variable for this 0-form, which can be differentiated only once in primary 1D time to obtain angular velocity as a 1-form:

$$θ \left({\overline{τ}}^{0}\right) \to ω \left({\overline{τ}}^{1}\right) = δ \left[θ\right] \left({\overline{τ}}^{1}\right)$$

at the root of the search DAG (FIG. 2B). Then, the DAG may be expanded by adding new phenomenological links and/or latent co-chain sequences (FIG. 2C). The hypotheses are numbered H-00 (the root) through H-15, enumerating all possible I-net structures formed by at most one latent co-chain complex in 1D time. The user may specify the maximum number of latent variables to keep the search tractable.

Not every introduction of new variables or relations makes nontrivial statements about physics. For example, the hypothesis H-01 produces a new variable typed as a 1-pseudo-form

$$T \left({\tilde{τ}}^{1}\right) = ƚ \left(θ \left(* {\tilde{τ}}^{1}\right)\right) ,$$

where the ∗ operator takes τ̃¹ to its dual:

$$* \left({\tilde{τ}}^{0} , {\tilde{τ}}^{0} + ∈\right) = {\tilde{τ}}^{0} + \frac{∈}{2} .$$

However, until this new variable is reached through another path to close a cycle and pose a nontrivial equation, one does not have a complete hypothesis to validate or invalidate against data. Further down the search DAG, H-08 defines a new variable typed as a 0-pseudo-form

$$L \left({\tilde{τ}}^{0}\right) = {ƚ}_{1} \left(θ \left(* {\tilde{τ}}^{0}\right)\right) ,$$

where

$$* {\tilde{τ}}^{0} = \left({\tilde{τ}}^{0} - \frac{∈}{2} , {\tilde{τ}}^{0} + \frac{∈}{2}\right) .$$

The co-boundary operation

$$L \left({\tilde{τ}}^{0}\right) \to T \left({\tilde{τ}}^{1}\right) \to δ \left[L\right] \left({\tilde{τ}}^{1}\right) ,$$

closes the cycle and produces a commutative diagram (FIG. 2C) leading to the following residual error equation:

$${ε}_{H - 08} \left(θ ; {f}_{1} , {f}_{2}\right) = {f}_{1} \left(θ\right) - δ ∗ \left[{f}_{2} \left(δ \left[θ\right] 0\right)\right] = 0 \qquad \text{EQ. 1}$$

where

$${ƚ}_{1} , {ƚ}_{2}$$

are selected from restricted function spaces

$${F}_{1} , {F}_{2}$$

to avoid over fitting (e.g., parameterized by a linear combination of domain-aware basis functions) and their parameters must be determined from data to minimize the residual error

$${ε}_{H - 08}$$

over the entire period of data collection. A loss function can, for example, be defined as a mean-squared-error (MSE) to penalize violations uniformly over the time series period:

$$L o s {s}_{H - 08} = m i {n}_{{f}_{1} ∈ {F}_{1}} m i {n}_{{f}_{2} ∈ {F}_{2}} {\left‖{ε}_{H - 08} \left(θ ; {f}_{1} , {f}_{2}\right)\right‖}_{{\tilde{τ}}^{1}} \qquad \text{EQ 2}$$

where

$${\left‖⋅\right‖}_{{\tilde{τ}}^{1}}$$

is an L₂-norm computed as a temporal integral (i.e., sum of squared errors

$${ε}_{H - 08}^{2} \left(0 ; {f}_{1} , {f}_{2}\right)$$

over time intervals τ̃¹ where

$${ε}_{H - 08} \left(θ ; {ƚ}_{1} , {ƚ}_{2}\right)$$

is evaluated.

In this example, the best t is achieved with

$${ƚ}_{1} \left(θ\right) = {c}_{1} sin θ$$

and

$${ƚ}_{2} \left(ω\right) = {c}_{2} ω$$

where

$$\frac{{c}_{2}}{{c}_{1}} = \frac{- g}{r} .$$

The latent variables L(τ̃⁰) and T(τ̃¹) turn out to be the familiar notions of angular momentum and torque, respectively, although the software need not know anything about angular momentum and torque to generate and test what-if scenarios about the existence of angular momentum and torque and the correlations of angular momentum and torque with angular position and velocity. Hence, the interpretability of the discovered relationships by a human scientist does not require predisposing the AI associate to such interpretations. As such, the AI associate described herein have the ability to discover new notions and correlations.

In general, every state (or node) in the search DAG can be classified as complete or incomplete hypotheses. Complete hypotheses are I-net structures with dangling branches that carry no new nontrivial information in addition to their parent states. Every time such a branch is turned into one or more closed cycles by adding enough new variables and/or relations, a new constraint is hypothesized that can be evaluated against data. When adding new dangling branches to the I-net structure, the search algorithm may prioritize actions that produce I-net structures similar to existing Tonti diagrams by assigning a penalty factor to every violation of the common structure (e.g., diagonal phenomenological links connecting non-dual cells). The loss for complete hypotheses can be computed as the sum of the penalties for the I-net structure and the sum of residual errors for each of the independent constraints implied by converging paths times a use-specified number that determines the relative weight of the penalties and the errors. For example, an A* algorithm may be used to search the space of hypotheses. However, since the error loss for incomplete hypotheses cannot be computed, the incomplete hypotheses may be pruned when the increase in their penalty is so great that it would fail even if it had no error loss at all.

Advantageously, a practical features of the methods and systems described is that implementation of said methods and systems via Python allows for automatic conversion of I-net instances to symbolic DE expressions in SymPy, when the co-boundary operators are interpreted in a differential setting for infinitesimal cells

$$\left(ε \to {0}^{+}\right) .$$

For example, EQ. 1 may be rewritten as a nonlinear ODE:

$${ε}_{H - 08} \left(θ ; {f}_{1} , {f}_{2}\right) = {f}_{1} \left(θ\right) - \frac{ϑ}{ϑ t} \left[{f}_{2} \left(\dot{θ} \left(\text{t}\right)\right)\right] = 0 \qquad \text{EQ. 3}$$

As a result, the generated hypotheses may be evaluated using any number of existing machine learning or symbolic regression frameworks that standardize on ordinary differential equations and/or partial differential equations (ODE/PDE) inputs. For example, using non-orthogonal basis functions

$$\left\{1 , x , {x}^{2} , sin x , cos x\right\}$$

to span both function spaces

$${F}_{1} , {F}_{2} ,$$

one can substitute for both symbolic functions:

$${f}_{1} \left(θ\right) : = {c}_{0}^{1} + {c}_{1}^{1} θ + {c}_{2}^{1} {θ}^{2} + {c}_{3}^{1} sin θ + {c}_{3}^{1} cos θ \qquad \text{EQ. 4}$$

$${f}_{1} \left(θ\right) : = {c}_{0}^{2} + {c}_{1}^{2} \dot{θ} + {c}_{2}^{2} {\dot{θ}}^{2} + {c}_{3}^{2} sin \dot{θ} + {c}_{3}^{2} cos \dot{θ} \qquad \text{EQ. 5}$$

into EQ. 3 to obtain a symbolic second-order (non)linear ODE in SymPy.

Next, an algebraic simplification may be performed (e.g., using the software) to identify equivalence classes of hypotheses that, despite coming from different I-net structures, lead to the same ODE upon differential interpretation of the I-nets. For ODEs which, after simplification, are linear combinations of nonlinear (differential/algebraic) terms that are computable from data, one can apply symbolic regression to estimate the coefficients from data. For example, continuing with the pendulum example, LASSO-regularized least squares regression was used in PDE-FIND where each term involving a derivative is evaluated using finite difference or polynomial approximation. Both energy (first-order) and torque (second-order) forms of the governing equation were discovered without human intervention. The former was quite unexpected, since its I-net structure does not correspond to a Tonti diagram. The latter has a larger error due to finite difference discretization.

In instances where the differential equations have terms that have nested nonlinear functions (i.e., cannot be represented as a linear combination of nonlinear terms because of unknown coefficients embedded within each term), more sophisticated regression and/or nonlinear programming methods may be needed. Alternatively, the I-net structures may be directly mapped to computation graphs in PyTorch, skipping differential interpretation to symbolic differential equations altogether.

Further, numerical approximation of symbolic PDEs may be difficult because the discrete forms (in 3D space) may not obey the conservation principles postulated by the I-net structure after such approximations. It is difficult to separate discretization errors from modeling errors and noise in data. One of the key advantages of I-nets is the rich geometric information in their type system that is fundamental to physics-compatible and mimetic discretization schemes that ensure conservation laws are satisfied exactly as a discrete level, regardless of spatial mesh or time-step resolutions. Such information is lost upon conversion to symbolic DEs. Retaining this information is even more important when dealing with noisy data, because discrete differentiation of noisy data (e.g., via finite difference formulae) may substantially amplify the noise. Advantageously, the same I-net instance can be directly interpreted in integral form to generate equations over larger regions in space and/or time, to make the computations more resilient to noise. For example, in the heat equation, the discrete divergence of heat flux over a single 3-cell may be replaced by a flux integral over a collection of 3-cells, and is equated against the volumetric integral of internal energy within the collection. The cancellation of internal surface fluxes (discrete form of Gauss’ divergence theorem) may be built into the interpretation based on cellular homology. The integrals may be computed using higher-order integration schemes (e.g., using polynomial interpolation with underfitting to filter the noise).

For a given viable hypothesis generated as an abstract (symbolic) I-net instance and a combinatorial decomposition of the data space (e.g., 3D space, 1D time, networks/circuits, or their combinations), the software instantiates a discrete (cellular) I-net subtype in which the variables are tensors of numerical values associated to various cells in the cell complex, ordered arbitrarily, and co-boundary operators are defined concretely by sparse tensor multiplications with incidence tensors, which are populated by 0 or 1 values for bookkeeping incidence relations within the cell complex. For example, in the pendulum case, the two dual copies of 1D time are discretized into staggered instants

$${\overline{τ}}_{0}^{0} , {\overline{τ}}_{0}^{1} , … , {\overline{τ}}_{n}^{0}$$

and

$${\tilde{τ}}_{0}^{0} , {\tilde{τ}}_{1}^{0} , … , {\tilde{τ}}_{n - 1}^{0}$$

and intervals

$${\tilde{τ}}_{i}^{1} = \left({\tilde{τ}}_{i}^{0} , {\tilde{τ}}_{i + 1}^{0}\right) ∍ {\overline{τ}}_{i}^{1} = \left({\overline{τ}}_{i}^{0} , {\overline{τ}}_{i + 1}^{0}\right) ∍ {\tilde{τ}}_{i}^{0} .$$

This discretization may be viewed as a simple pair of cell complexes with n primary 0-cell and secondary 1-cells, m=n-1 primarily 1-cells and secondary 0-cells. The incidence relationships between the cell complexes (e.g., illustrated in FIG. 2C) may be described as:

$${δ}_{j , i} = \left\{\begin{matrix}+ 1 , & i f \text{EQ. 6} {\overline{τ}}_{j}^{1} = \left({\overline{τ}}_{i}^{0} , {\overline{τ}}_{i + 1}^{0}\right) \\ - 1 , & i f {\overline{τ}}_{j}^{1} = \left({\overline{τ}}_{i - 1}^{0} , {\overline{τ}}_{i}^{0}\right) \\ 0 , & o t h e r w i s e\end{matrix}\right)$$

$${δ}_{i , j}^{*} = \left\{\begin{matrix}+ 1 , & i f \text{EQ. 7} {\tilde{τ}}_{j}^{1} = \left({\tilde{τ}}_{i}^{0} , {\tilde{τ}}_{i + 1}^{0}\right) \\ - 1 , & i f {\overline{τ}}_{j}^{1} = \left({\overline{τ}}_{i - 1}^{0} , {\overline{τ}}_{i}^{0}\right) \\ 0 , & o t h e r w i s e\end{matrix}\right)$$

It is easy to verify that

$${δ}_{j , i} = {δ}_{i , j}^{∗} .$$

The above definitions are generalized to arbitrary cell complexes in higher dimensions, where the incidence number is ±1 when a d-cell

$${σ}_{i}^{d}$$

is on the boundary of a

$$\left(\text{d+1}\right) \text{-cell} {σ}_{j}^{d + 1}$$

and the sign is determined by their relative orientations, and 0 otherwise. The angular position

$$θ \left({\tilde{τ}}^{0}\right) ,$$

velocity

$$ω \left({\tilde{τ}}^{1}\right) ,$$

momentum

$$L \left({\tilde{τ}}^{0}\right) ,$$

and torque

$$L \left({\tilde{τ}}^{1}\right)$$

in the 4-cycle abstract I-net instance described above relative to the pendulum are instantiated as

$${\left[θ\right]}_{n \times 1} , {\left[ω\right]}_{m \times 1} , {\left[L\right]}_{m \times 1} ,$$

and

$${\left[T\right]}_{n \times 1} ,$$

respectively. Note that these variables are integral properties, hence

$${\left[ω\right]}_{m \times 1}$$

and

$${\left[T\right]}_{n \times 1}$$

are to be interpreted as angular position difference and impact in a discrete setting, to be precise. The co-boundary operators in EQ. 1 are defined byleft-action of sparse matrices

$${\left[δ\right]}_{m \times n}$$

and

$${\left[{δ}^{*}\right]}_{n \times m}$$

on the variable. The phenomenological functions

$${ƚ}_{1}$$

and

$${ƚ}_{2} ,$$

on the other hand, are decorated with basis functions and unknown coefficients, which are still symbolic.

In higher-dimensional spacetime, the variables are defined by higher-rank tensors, whose indices associate the tensors to space, time, network/circuit, and the variable’s own tensorial components (e.g., 3 for vectors in 3D). The incidence tensors and phenomenological links are defined in a straightforward fashion.

Using the cellular constructs, the software instantiates numerical (tensor-based) I-net instances as feedforward computation graphs in PyTorch. Every topological operator or phenomenological function in the numerical (tensor-based) I-net structure is mapped to a machine learning layer in the forward subroutine, while the unknown (phenomenological) coefficients are declared as training parameters.

The discretization of time derivative via EQS. 6 and 7 is not robust to noise, as it is equivalent to simple central difference on staggered grids. The same is true for higher-dimensional cases. To resolve this issue, the incidence tensors may be generalized to consume data from larger neighborhoods in spacetime, using local polynomial underfitting, resulting in a Savitzky-Golay filtering scheme generalized to arbitrary dimensions. The tensor-based computation remains intact, except that incidence tensors will be less sparse. Further, for Cartesian grids (in space and/or time), the incidence tensor multiplications can be replaced with efficient convolutions with repeating stencils, thereby enabling rapid computations on the GPU via fast Fourier transforms (FFTs) or convolutional neural networks (CNNs). For example, the tensor product

$${\left[ω\right]}_{\left(n - 1\right) \times 1} = {\left[δ\right]}_{\left(n - 1\right) \times n} ⋅ {\left[θ\right]}_{n \times 1}$$

can be implemented as

$${\left[ω\right]}_{\left(n - 1\right) \times 1} = {\left[θ\right]}_{n \times 1} ⋆ \left[- 1 , + 1\right]$$

which produces the effect of sliding the stencil [-1, +1] along the time series data and computing a finite difference formula. Higher-order differentiation and integration in higher-dimensional settings (e.g., the divergence of heat flux in 3D can be interpreted in integral form as a heat flux over the boundary of sliding control volume) may be computed as a convolution with quadrature weights sampled on the boundary.

“Computer-readable medium” or “non-transitory, computer-readable medium,” as used herein, refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and prior art-recognized equivalents and successor media, in which the software implementations embodying the present techniques are stored.

The methods described herein can, and in many embodiments must, be performed using computing devices or processor-based devices that include a processor; a memory coupled to the processor; and instructions provided to the memory, wherein the instructions are executable by the processor to perform the methods described herein (such computing or processor-based devices may be referred to generally by the shorthand “computer”). For example, a system may comprise: a processor; a memory coupled to the processor; and instructions provided to the memory, wherein the instructions are executable by the processor to cause the system to perform a method comprising: describing a context for a physical system in terms of an underlying topology and a domain of interest; defining a plurality of physical variables and relation types based on the underlying topology and the domain of interest; representing a plurality of testable hypotheses each as a network or graph-like structure comprising physical relationships among the physical variables, wherein the physical relationships are selected from the relationship types, and wherein, within the network or graph-like structure, the physical variables are nodes and the physical relationships are edges; interpreting at least one of the testable hypotheses into analytical and/or computational forms with a combination of known and unknown variables; and validating or invalidating the at least one of the testable hypotheses by (a) fitting the unknown parameters to data relating to the physical system and (b) evaluating a goodness of fit for the fitting.

Similarly, any calculation, determination, or analysis recited as part of methods described herein may be carried out in whole or in part using a computer.

Furthermore, the instructions of such computing devices or processor-based devices can be a portion of code on a non-transitory computer readable medium. Any suitable processor-based device may be utilized for implementing all or a portion of embodiments of the present techniques, including without limitation personal computers, networks, personal computers, laptop computers, computer workstations, mobile devices, multi-processor servers or workstations with (or without) shared memory, high performance computers, and the like. Moreover, embodiments may be implemented on application specific integrated circuits (ASICs) or very large scale integrated (VLSI) circuits.

### Example Embodiments

Embodiment 1. A method for identifying scientific hypotheses, the method comprising: describing a context for a physical system in terms of an underlying topology and a domain of interest; defining a plurality of physical variables and relation types based on the underlying topology and the domain of interest; representing a plurality of testable hypotheses each as a network or graph-like structure comprising physical relationships among the physical variables, wherein the physical relationships are selected from the relationship types, and wherein, within the network or graph-like structure, the physical variables are nodes and the physical relationships are edges; interpreting at least one of the testable hypotheses into analytical and/or computational forms with a combination of known and unknown variables; and validating or invalidating the at least one of the testable hypotheses by (a) fitting the unknown parameters to data relating to the physical system and (b) evaluating a goodness of fit for the fitting.

Embodiment 2. The method of Embodiment 1, wherein the underlying topology pertains to a physical space of the physical system, a time of the physical system, a spacetime of the physical system, an abstract system network of the physical system, or any combination thereof.

Embodiment 3. The method of any one of Embodiments 1-2, wherein the domain of interest comprises a mechanical domain, an electrical domain, a thermal domain, or any combination thereof.

Embodiment 4. The method of any one of Embodiments 1-3, wherein the types of physical variables are parameters within and/or derived from the data relating to the physical system.

Embodiment 5. The method of any one of Embodiments 1-4, wherein the relationship types comprise one or more selected from the group consisting of: a topological relation, a metric relation, an algebraic relation, a differential operator, an integral operator, and an interpolative operator.

Embodiment 6. The method of any one of Embodiments 1-5, wherein the relationship types are derived by prescribing, defining, and/or constraining a conservation law and/or a constitutive law.

Embodiment 7. The method of any one of Embodiments 1-6, wherein the plurality of testable hypotheses are arranged in a search space that is represented by a directed acyclic graph (DAG) whose nodes are the testable hypotheses and edges are the actions in the search space representing one or more of: (a) adding one or more new relations among existing physical variables; or (b) defining one or more new physical variables linked to one or more existing variables with one or more new physical relations.

Embodiment 8. The method of Embodiment 7 further comprising: performing the interpreting and the validating or invalidating for multiple of the plurality of testable hypotheses, wherein the interpreting and the validating or invalidating for the multiple of the plurality of testable hypotheses is performed for simpler testable hypotheses and proceeds to other testable hypotheses that adds complexity incrementally if the simpler hypotheses do not explain the data adequately.

Embodiment 9. The method of any one of Embodiments 1-8, wherein the network or graph-like structure comprises one or more equations in terms of the physical variables and the known and unknown parameters, and wherein the validating or invalidating comprises fitting the one or more equations to available data.

Embodiment 10. The method of any one of Embodiments 1-9, wherein the at least one of the testable hypotheses comprises at least one of conservation laws derived from first principles applied to (a) the underlying topology, (b) phenomenological, empirical, constitutive, material, or multi-physics interaction laws expressed in algebraic terms with the unknown parameters, and (c) initial or boundary conditions.

Embodiment 11. The method of any one of Embodiments 1-10, wherein the fitting is guided by a loss function, an error function, a cost function, an objective function, a utility function, or penalty function that quantifies how well a testable hypothesis explains the data.

Embodiment 12. The method of any one of Embodiments 1-11, wherein the data is provided by simulation, experiment, or a combination of both.

Embodiment 13. The method of any one of Embodiments 1-12, wherein the analytical and/or computational forms comprises one or more of: a differential equation, an integral equation, an integro-differential equation, a discrete-algebraic equation, and a system model.

Embodiment 14. The method of any one of Embodiments 1-13 further comprising: outputting and/or displaying at least one of: (a) the underlying topology and the domain of interest, (b) the network or graph-like structure for the at least one of the testable hypotheses, (c) the analytical and/or computational forms for the at least one of the testable hypotheses, (d) the search space, (e) the validation or invalidation for the at least one of the testable hypotheses, and (f) the goodness of fit for the at least one of the testable hypotheses.

Embodiment 15. The method of any one of Embodiments 1-14 further comprising: collecting additional data; and validating or invalidating at least some of the plurality of testable hypotheses with the additional data.

Embodiment 16. The method of any one of Embodiments 1-15, wherein the interpreting of the at least one of the testable hypotheses comprises mapping the physical variables to tensor data and physical relationships to computational operators in a computational framework.

Embodiment 17. A computing system comprising: a processor; a memory coupled to the processor; and instructions provided to the memory, wherein the instructions are executable by the processor to cause the system to perform the method of any of Embodiments 1-16.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer’s goals, such as compliance with system-related, business-related, government-related and other constraints, which vary by implementation and from time to time. While a developer’s efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method for identifying, generating, and/or evaluating scientific hypotheses, the method comprising:
describing a context for a physical system in terms of an underlying topology and a domain of interest;
defining a plurality of physical variables and relation types based on the underlying topology and the domain of interest;
representing a plurality of testable hypotheses each as a network or graph-like structure comprising physical relationships among the physical variables, wherein the physical relationships are selected from the relationship types, and wherein, within the network or graph-like structure, the physical variables are nodes and the physical relationships are edges;
interpreting at least one of the testable hypotheses into analytical and/or computational forms with a combination of known and unknown variables; and
validating or invalidating the at least one of the testable hypotheses by (a) fitting the unknown parameters to data relating to the physical system and (b) evaluating a goodness of fit for the fitting.

2. The method of claim 1, wherein the underlying topology pertains to a physical space of the physical system, a time of the physical system, a spacetime of the physical system, an abstract system network of the physical system, or any combination thereof.

3. The method of claim 1, wherein the domain of interest comprises a mechanical domain, an electrical domain, a thermal domain, or any combination thereof.

4. The method of claim 1, wherein the types of physical variables are parameters within and/or derived from the data relating to the physical system.

5. The method of claim 1, wherein the relationship types comprise one or more selected from the group consisting of: a topological relation, a metric relation, an algebraic relation, a differential operator, an integral operator, and an interpolative operator.

6. The method of claim 1, wherein the relationship types are derived by prescribing, defining, and/or constraining a conservation law and/or a constitutive law.

7. The method of claim 1, wherein the plurality of testable hypotheses are arranged in a search space that is represented by a directed acyclic graph whose nodes are the testable hypotheses and edges are the actions in the search space representing one or more of:
(a) adding one or more new relations among existing physical variables; or
(b) defining one or more new physical variables linked to one or more existing variables with one or more new physical relations.

8. The method of claim 7 further comprising:
performing the interpreting and the validating or invalidating for multiple of the plurality of testable hypotheses, wherein the interpreting and the validating or invalidating for the multiple of the plurality of testable hypotheses is performed for simpler testable hypotheses and proceeds to other testable hypotheses that adds complexity incrementally if the simpler hypotheses do not explain the data adequately.

9. The method of claim 1, wherein the network or graph-like structure comprises one or more equations in terms of the physical variables and the known and unknown parameters, and wherein the validating or invalidating comprises fitting the one or more equations to available data.

10. The method of claim 1, wherein the at least one of the testable hypotheses comprises at least one of conservation laws derived from first principles applied to (a) the underlying topology, (b) phenomenological, empirical, constitutive, material, or multi-physics interaction laws expressed in algebraic terms with the unknown parameters, and (c) initial or boundary conditions.

11. The method of claim 1, wherein the fitting is guided by a loss function, an error function, a cost function, an objective function, a utility function, or penalty function that quantifies how well a testable hypothesis explains the data.

12. The method of claim 1, wherein the data is provided by simulation, experiment, or a combination of both.

13. The method of claim 1, wherein the analytical and/or computational forms comprises one or more of: a differential equation, an integral equation, an integro-differential equation, a discrete-algebraic equation, and a system model.

14. The method of claim 1 further comprising:
outputting and/or displaying at least one of: (a) the underlying topology and the domain of interest, (b) the network or graph-like structure for the at least one of the testable hypotheses, (c) the analytical and/or computational forms for the at least one of the testable hypotheses, (d) the search space, (e) the validation or invalidation for the at least one of the testable hypotheses, and (f) the goodness of fit for the at least one of the testable hypotheses.

15. The method of claim 1 further comprising:
collecting additional data; and
validating or invalidating at least some of the plurality of testable hypotheses with the additional data.

16. The method of claim 1, wherein the interpreting of the at least one of the testable hypotheses comprises mapping the physical variables to tensor data and physical relationships to computational operators in a computational framework.

17. A computing system comprising:
a processor;
a memory coupled to the processor; and
instructions provided to the memory, wherein the instructions are executable by the processor to cause the system to perform a method comprising:
describing a context for a physical system in terms of an underlying topology and a domain of interest;
defining a plurality of physical variables and relation types based on the underlying topology and the domain of interest;
representing a plurality of testable hypotheses each as a network or graph-like structure comprising physical relationships among the physical variables, wherein the physical relationships are selected from the relationship types, and wherein, within the network or graph-like structure, the physical variables are nodes and the physical relationships are edges;
interpreting at least one of the testable hypotheses into analytical and/or computational forms with a combination of known and unknown variables; and validating or invalidating the at least one of the testable hypotheses by (a) fitting the unknown parameters to data relating to the physical system and (b) evaluating a goodness of fit for the fitting.
